(19) United States
(12) Patent Application Publication
(10) Pub. No.: US 2012/0162098 A1
(43) Pub. Date: Jun. 28, 2012

(54) PORTABLE ELECTRONIC APPARATUS

(76) Inventors: Victoria Janet Aboud, Toronto (CA); Robert Bambang, Jakarta (ID); Hyun Joo Lee, Bucheon (KR)

(21) Appl. No.: 13/076,615

(22) Filed: Mar. 31, 2011

Related U.S. Application Data
(60) Provisional application No. 61/426,934, filed on Dec. 23, 2010.

(51) Int. Cl. G06F 3/041; G08B 21/00

(52) U.S. Cl. 345/173; 340/635

(57) ABSTRACT

A portable electronic apparatus is disclosed. The portable electronic apparatus includes a processor circuit enabled to execute a plurality of programs. The portable electronic apparatus also includes an output device for outputting output from the processor circuit. The portable electronic apparatus further includes an input device for receiving input, the input for controlling the processor circuit. In addition, the portable electronic apparatus includes an indicator for indicating a program being executed by the processor circuit.

### CROSS REFERENCE TO RELATED APPLICATION

This application claims priority to Provisional Application Ser. No. 61/426,934, filed on Dec. 23, 2010, the contents of which are incorporated by reference in their entirety.

### BACKGROUND OF THE INVENTION

1. Field of Invention

The present invention relates to a portable electronic apparatus and more particularly to a portable electronic apparatus with an indicator.

2. Description of Related Art

Portable electronic apparatus such as tablet devices are known in the art. They may include various features such as touchscreen technology, cameras, speakers and microphones. Furthermore, most portable electronic apparatus are capable of running different programs.

With the advancement of portable electronic apparatus, the apparatus are becoming more common in everyday usage. For example, the apparatus are now often used in educational institutions, such as universities, by students to enhance their learning experience. Along with the increase in popularity of portable electronic apparatus, comes more interest in developing programs that are capable of being run the portable electronic apparatus. This interest has resulted in a large number of programs being available for portable electronic apparatus in recent years where these programs may often be downloaded over the Internet.

The programs generally fall into one of several different types of programs. For example, one type of programs could be games such as a Solitare program. Another example of a type of programs could be educational programs such as a phonics program. These examples of types of programs are clearly not exhaustive as types programs such as accounting programs, word processing programs, navigation programs, etc.

### SUMMARY OF THE INVENTION

In accordance with an aspect of the invention, there is provided a portable electronic apparatus having front and back opposing sides. The portable electronic apparatus includes a processor circuit enabled to execute a plurality of programs. The portable electronic apparatus also includes an output device for outputting output from the processor circuit. The portable electronic apparatus further includes an input device for receiving input. The input is for controlling the processor circuit. In addition, the portable electronic apparatus includes an indicator for indicating a program being executed by the processor circuit.

In accordance with another aspect of the invention, there is provided a method for determining a program being executed on a processor circuit. The method involves executing the program on the processor circuit. The method also involves outputting output to an output device from the processor circuit. The method further involves controlling the processor circuit using input from an input device. Furthermore, the method indicating the program being executed wherein indicating involves using an indicator.

In accordance with yet another aspect of the invention, there is provided a portable electronic tablet device for children. The portable electronic tablet device for children includes a body comprising acrylonitrile butadiene styrene. The portable electronic tablet device for children also includes a processor circuit enabled to execute a plurality of programs. The plurality of programs includes games and educational programs. The portable electronic tablet device for children further includes a touchscreen device in communication with the processor circuit. The touchscreen device is 7 inches diagonally. Furthermore, the portable electronic tablet device for children includes a plurality of cameras controlled by the processor circuit. In addition, the portable electronic tablet device for children includes an indicator for indicating a type of program being executed by the processor circuit. Also, the indicator provides environmental lighting to reduce eyestrain.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a front view of a portable electronic apparatus in accordance with an embodiment of the invention;

FIG. 2 is a back view of the portable electronic apparatus in FIG. 1;

FIG. 3 is a side view of the portable electronic apparatus in FIG. 1;

FIG. 4 is a schematic view of the internal circuitry of the portable electronic apparatus in FIG. 1;

FIG. 5 is a front view of a portable electronic apparatus in accordance with another embodiment of the invention; and

FIG. 6 is a back view of the portable electronic apparatus in FIG. 5.

### DETAILED DESCRIPTION

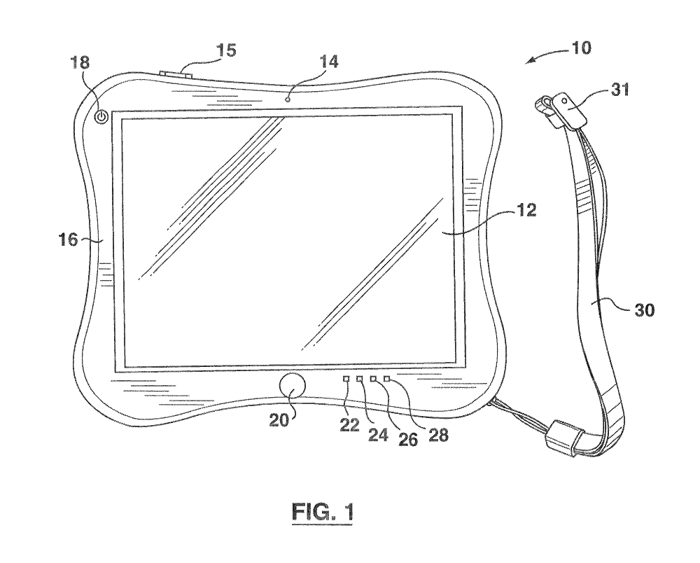

Referring to FIG. 1, a front view of a portable electronic apparatus according to an embodiment of the invention is shown generally at 10. The apparatus 10 includes a screen 12 and a body 16. The portable electronic apparatus 10 also includes a microphone 14, a connector 15, and an adjustable wrist strap 30 with an adjustment mechanism 31. The portable electronic apparatus 10 further includes a power button 18, an interactive button 20 and a plurality of front lights 22, 24, 26, and 28.

In this embodiment, the screen 12 is a conventional touchscreen. Some examples of common touchscreen technologies that are suitable for the apparatus 10 are resistive system touchscreens, capacitive system touchscreens and surface acoustic wave system touchscreens. In addition, other less common less common touchscreen technologies may be used with the apparatus 10. In other embodiments, it will be appreciated that a conventional display screen such as an LCD screen may be used if other input means are provided. Other input means include devices such as a keyboard, a track pad, or a track ball.

In this embodiment, the body 16 is a durable lightweight material. The material should be lightweight so that the apparatus 10 is light and easy to carry making the apparatus more portable. The material should also be durable to protect the internal components of the apparatus 10. For example, a suitable material to use for the body is plastic. In particular, acrylonitrile butadiene styrene was found to be a good material for the body 16. In other embodiments, other materials with suitable characteristics for a specific application may be used.

In the embodiment shown, the connector 15 is primarily for supplying power to the portable apparatus 10 when connected to a power source. The apparatus 10 includes a battery (not shown) to power the apparatus. The connector 15 may also be used to connect the apparatus 10 to another device for data sharing. For example, the apparatus 10 may be connected to a personal computer through the connector 15 in order to download programs onto the apparatus. Therefore, the connector 15 may be a standard USB™ connector; however, any other type of connector capable of charging the apparatus 10 would be suitable. In other embodiments, it will be appreciated that if a portable electronic apparatus was equipped with replaceable batteries or inductive charging technology, no connector would be required.

In this embodiment, the wrist strap 30 includes an adjustment mechanism 31 so that the length of the wrist strap may be adjusted to fit wrists of different sizes. The wrist strap 30 and adjustment mechanism 31 provide a means by which the portable electronic apparatus 10 may be carried while leaving both hands of a user free. In addition, the wrist strap 30 would prevent the apparatus 10 from being accidentally dropped if the apparatus were to slip out of a user's hand. This would be particularly useful for small children and toddlers who would be more likely to drop items due to less developed motor skills.

In this embodiment, the interactive button 20 may serve many functions. Since the screen 12 is a touchscreen which already provides a source of input, the interactive button 20 may be used as a shortcut key. For example, the interactive button 20 may be used as a home key to return the user to a home screen. Alternatively, the interactive button 20 could be used to run a specific application such as a game or an educational program.

In the embodiment shown, the plurality of front lights 22, 24, 26, and 28 disposed on the front of the portable electronic apparatus 10 serve as additional sources of output. The plurality of front lights 22, 24, 26, and 28 may serve different functions depending on the program that the apparatus 10 is running. For example, if a multiplayer game is being played, plurality of front lights 22, 24, 26, and 28 may be used to identify a specific player.

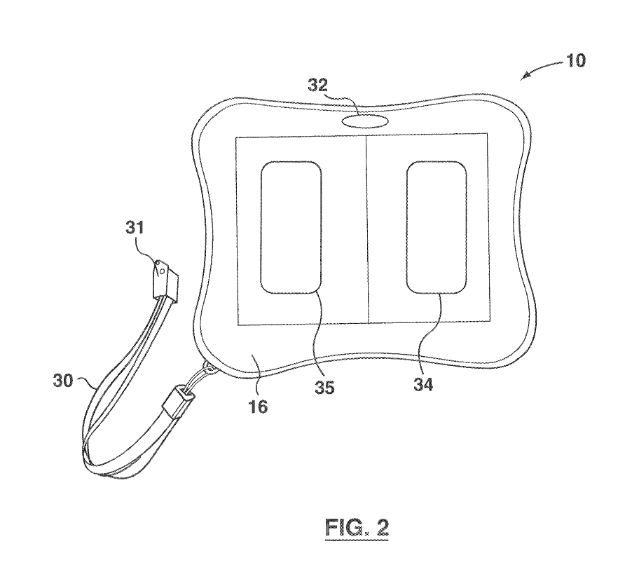

Referring to FIG. 2, a back view of the portable electronic apparatus 10 is generally shown. The apparatus 10 further includes a speaker 32 and a plurality of back lights 34 and 35. The speaker 32 generates sound. It should be appreciated that in other embodiments, a speaker may be placed in any suitable location on the apparatus including the front of the apparatus.

In the embodiment shown, the plurality of back lights 34 and 35 may serve as an indicator of a program running on the portable electronic apparatus 10. One method of indicating the program is to cause the plurality of back lights 34 and 35 to emit a different colour dependent on the program that is running. Alternatively, the plurality of back lights 34 and 35 may also emit light of different intensities or a combination different colors and intensities for different programs. By indicating the program running on the portable electronic apparatus 10 using the plurality of back lights 34 and 35, it allows a third person who may not be able to see the screen 12 of the apparatus to readily determine what program is running. The plurality of back lights 34 and 35 may provide the same indication for several programs classified within a specific type of programs. For example, running a program classified as a game on the portable electronic apparatus 10 may cause the plurality of back lights 34 and 35 to emit red, while running a program classified as an educational program may cause the plurality of back lights 34 and 35 to emit green. Therefore, this would allow a third person to determine if the portable electronic apparatus 10 is being used for entertainment purposes or for educational purposes. A useful application of this feature is apparent if the user of the portable electronic apparatus 10 was a child or toddler. The plurality of back lights 34 and 35 would allow a parent to determine whether a child is playing too many games instead of running educational programs. It will be appreciated that any indication means would be suitable. In particular, it will be appreciated that a different number of back lights may be used.

In addition, the plurality of back lights 34 and 35 may be used to provide environmental lighting as part of an environmental lighting system. Environmental lighting includes a continuous band of light around the screen 12 of the portable electronic apparatus 10 to reduce eye strain that may be caused by looking at the screen in a darkened room. The environmental lighting from the plurality of back lights 34 and 35 reduces glare and reflections that emanates directly from the screen 12 in a dark room. Glare and reflections cause the iris of an eye to rapidly adjust to light and dark images rapidly which inevitably leads to strain and fatigue of the eye. By providing environmental lighting from the plurality of back lights 34 and 35, the amount of glare and reflection is greatly reduced which results is less adjustment by the iris. Therefore, fatigue caused by watching the screen 12 in a darkened room is reduced.

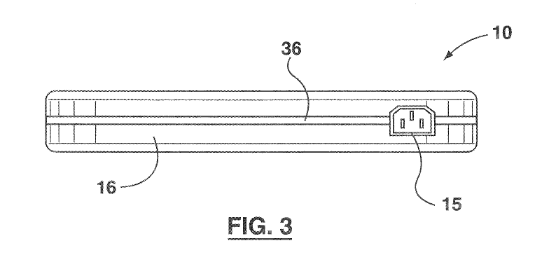

Referring to FIG. 3, a side view of the portable electronic apparatus 10 is generally shown. The portable electronic apparatus 10 further includes a side light 36 which extends along all four sides of the apparatus. The side light 36 may also serve as an indicator of a program running on the portable electronic apparatus 10 in addition to the plurality of back lights 34 and 35.

One method of indicating the program is to cause the side light 36 to emit a different colour dependent on the program that is running. Alternatively, the side light 36 may also emit light of different intensities for different programs. By indicating the program running on the portable electronic apparatus 10 using the side light 36, it allows a third person who may not be able to see the screen 12 or the plurality of back lights 34 and 35 of the apparatus 10 to readily determine what program is running. The side light 36 may provide the same indication for several programs classified within a type of programs. For example, running a program classified as a game on the portable electronic apparatus 10 may cause the side light 36 to emit red, while running a program classified as an educational program may cause the side light 36 to emit green. Therefore, this would allow a third person to determine if the portable electronic apparatus 10 is being used for entertainment purposes or for educational purposes. A useful application of this feature is apparent if the user of the portable electronic apparatus 10 was a child or toddler. The side light 36 would allow a parent to determine whether a child is playing too many games instead of running educational programs. It will be appreciated that any indication means would be suitable. In particular, it will be appreciated that in other embodiments, a side light may not extend around the entire apparatus or several side lights may be used.

In addition, the side light 36 may be used to provide environmental lighting as part of an environmental lighting system. Environmental lighting includes a continuous band of light around the screen 12 of the portable electronic apparatus 10 to reduce eye strain that may be caused by looking at the screen in a darkened room. The environmental lighting from the side light 36 reduces glare and reflections that emanate directly from the screen 12 in a darkened room. Glare and reflections cause the iris of an eye to rapidly adjust to light and dark images rapidly which inevitably leads to strain and fatigue of the eye. By providing environmental lighting from the side light 36, the amount of glare and reflection is greatly reduced which results is less adjustment by the iris. Therefore, fatigue caused by watching the screen 12 in a darkened room is reduced.

In this embodiment, it will be appreciated that the plurality of back lights 34 and 35 serve a similar function as the side light 36. Furthermore, it will be appreciated that in other embodiments of a portable electronic apparatus, a plurality of back lights may be replaced with a side light or the side light may be replaced with a plurality of back lights as long as some indication of the program being run on the portable electronic apparatus is visible by a third party that is unable to see the screen.

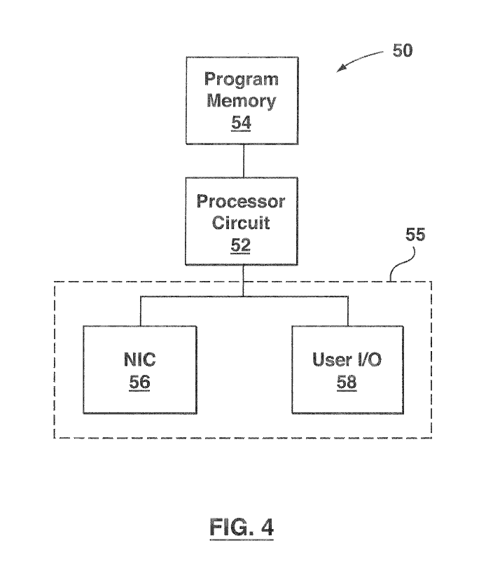

Referring to FIG. 4, internal circuitry for implementing the portable electronic apparatus 10 is shown generally at 50. In this embodiment, the internal circuitry 50 includes a processor circuit 52, a program memory 54, and an input output (I/O) component 55. Both of the program memory 54 and the I/O component 55 are in communication with the processor circuit 52.

The I/O component 55 includes a network interface card (NIC) 56 and a user I/O port 58. The network interface card 56 connects the portable electronic apparatus 10 to a network for downloading programs into the program memory 54. Therefore the network interface card 56 may be in communication with the connector 15. Alternatively, the network interface card 56 may also be connected to the network wirelessly using conventional technologies such as Wi-Fi™, Bluetooth™, cellular networks, etc. The user I/O port 58 connects the processor circuit 52 to I/O devices such as the screen 12, the speaker 32, the microphone 20, the interactive button 20, the plurality of front lights 22, 24, 26, and 28, the plurality of back lights 34 and 35 and the side light 36. It will be appreciated that other I/O devices may also be connect to the I/O port 58 for communication with the processor circuit 52.

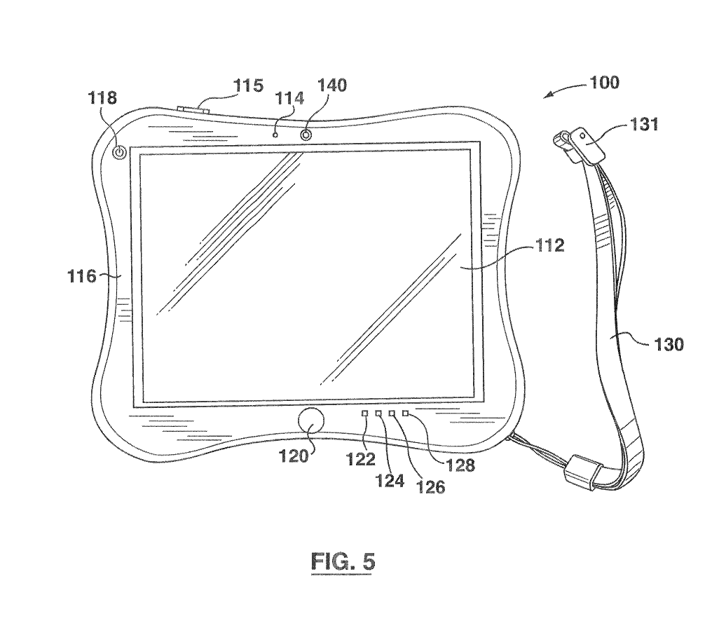

Referring to FIG. 5, a front view of a portable electronic apparatus according to another embodiment of the invention is shown generally at 100. The apparatus 100 includes a screen 112 and a body 116. The portable electronic apparatus 100 also includes a microphone 114, a connector 115, and an adjustable wrist strap 130 with an adjustment mechanism 131. The portable electronic apparatus 100 further includes a power button 118, an interactive button 120 and a plurality of front lights 122, 124, 126, and 128. In addition, the portable electronic apparatus 100 includes a camera 140.

In this embodiment, the screen 112 is a conventional touchscreen. Some examples of common touchscreen technologies that are suitable for the apparatus 100 are resistive system touchscreens, capacitive system touchscreens and surface acoustic wave system touchscreens. In addition, other less common less common touchscreen technologies may be used with the apparatus 100. In other embodiments, it will be appreciated that a conventional display screen such as an LCD screen may be used if other input means are provided. Other input means include devices such as a keyboard, a track pad, or a track ball.

In this embodiment, the body 116 is constructed from a durable lightweight material. The material should be lightweight so that the apparatus 100 is light and easy to carry making the apparatus more portable. The material should also be durable to protect the internal components of the apparatus 100. For example, a suitable material to use for the body is plastic. In particular, acrylonitrile butadiene styrene was found to be a good material for the body 116. In other embodiments, other materials with suitable characteristics for a specific application may be used.

In the embodiment shown, the connector 115 is primarily for supplying power to the portable apparatus 100 when connected to a power source. The apparatus 100 includes a battery (not shown) to power the apparatus. The connector 15 may also be used to connect the apparatus 100 to another device for data sharing. For example, the apparatus 100 may be connected to a personal computer through the connector 115 in order to download programs onto the apparatus. Therefore, the connector 115 may be a standard USB™ connector; however, any other type of connector capable of charging the apparatus 100 would be suitable. In other embodiments, it will be appreciated that if a portable electronic apparatus was equipped with replaceable batteries or inductive charging technology, no connector would be required.

In this embodiment, the wrist strap 130 includes an adjustment mechanism 131 so that the length of the strap may be adjusted to fit wrists of different sizes. The wrist strap 130 and adjustment mechanism 131 provide a means by which the portable electronic apparatus 100 may be carried while leaving both hands of a user free. In addition, the wrist strap 130 would prevent the apparatus 100 from being accidentally dropped if the apparatus were to slip out of a user's hand. This would be particularly useful for small children and toddlers who would be more likely to drop items due to less developed motor skills. Therefore, an ideal application of would be for a portable electronic tablet device for children.

In this embodiment, the interactive button 120 may serve many functions. Since the screen 112 is a touchscreen which already provides a source of input, the interactive button 120 may be used as a shortcut key. For example, the interactive button 120 may be used as a home key to return the user to a home screen. Alternatively, the interactive button 120 could be used to run a specific application such as a game or an educational program.

In the embodiment shown, the plurality of front lights 122, 124, 126, and 128 disposed on the front of the portable electronic apparatus 100 serve as additional sources of output. The plurality of front lights 122, 124, 126, and 128 may serve different functions depending on the program that the apparatus 100 is running. For example, if a multiplayer game is being played, plurality of front lights 122, 124, 126, and 128 may be used to identify a specific player.

In the embodiment shown in FIG. 5, the camera 140 is a source of input for the portable electronic apparatus 100. In this embodiment, the camera is a 1.3 mega-pixel camera configured to take pictures. Ideally, the camera would be small enough and light enough to be placed in the portable electronic apparatus 100 without making the apparatus large and bulky. Cameras that are commonly used in cellular telephones, webcams as well as other applications requiring a small camera may be used. The camera 140 is intended for taking a picture of the user of the portable electronic apparatus 100. In addition, the camera 140 is equipped with a video capture feature allowing the camera to capture video of the user. The video capture feature may be used for webcasting or video chatting. It will be appreciated that although the camera 140 is primarily intended to capture images and videos of the user, the portable electronic apparatus 100 may easily be turned around so that the camera may be used to capture images and video in front of the user. In other embodiments, addition input devices such as a capture button may be placed at a convenient location to allow a user to easily capture images with this camera.

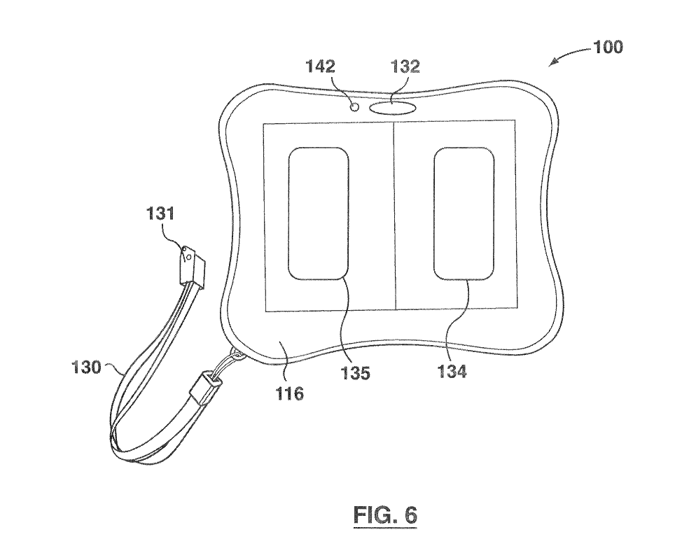

Referring to FIG. 6, a back view of the portable electronic apparatus 100 is generally shown. The apparatus 100 further includes a speaker 132 and a plurality of back lights 134 and 135. The speaker 132 generates sound. It should be appreciated that in other embodiments, a speaker may be placed in any suitable location on the apparatus including the front of the apparatus.

In the embodiment shown, the plurality of back lights 134 and 135 may serve as an indicator of a program running on the portable electronic apparatus 100. One method of indicating the program is to cause the plurality of back lights 134 and 135 to emit a different colour dependent on the program that is running. Alternatively, the plurality of back lights 134 and 135 may also emit light of different intensities or a combination different colors and intensities for different programs. By indicating the program running on the portable electronic apparatus 100 using the plurality of back lights 134 and 135, it allows a third person who may not be able to see the screen 112 of the apparatus to readily determine what program is running. The plurality of back lights 134 and 135 may provide the same indication for several programs classified within a specific type of programs. For example, running a program classified as a game on the portable electronic apparatus 100 may cause the plurality of back lights 134 and 135 to emit red, while running a program classified as an educational program may cause the plurality of back lights 134 and 135 to emit green. Therefore, this would allow a third person to determine if the portable electronic apparatus 100 is being used for entertainment purposes or for educational purposes. A useful application of this feature is apparent if the user of the portable electronic apparatus 100 were a child or toddler. The plurality of back lights 124 and 135 would allow a parent to determine whether a child is playing too many games instead of running educational programs. It will be appreciated that any indication means would be suitable. In particular, it will be appreciated that a different number of back lights may be used.

In addition, the plurality of back lights 134 and 135 may be used to provide environmental lighting as part of an environmental lighting system. Environmental lighting includes a continuous band of light around the screen 112 of the portable electronic apparatus 100 to reduce eye strain that may be caused by looking at the screen in a darkened room. The environmental lighting from the plurality of back lights 134 and 135 reduces glare and reflections that emanates directly from the screen 112 in a dark room. Glare and reflections cause the iris of an eye to rapidly adjust to light and dark images rapidly which inevitably leads to strain and fatigue of the eye. By providing environmental lighting from the plurality of back lights 134 and 135, the amount of glare and reflection is greatly reduced which results is less adjustment by the iris. Therefore, fatigue caused by watching the screen 112 in a darkened room is reduced.

In the embodiment shown in FIG. 6, the camera 142 is another source of input for the portable electronic apparatus 100. In this embodiment, the camera is a 1.3 mega-pixel camera configured to take pictures. Ideally the camera would be small enough and light enough to be placed in the portable electronic apparatus 100 without making the apparatus large and bulky. Cameras that are commonly used in cellular telephones, webcams as well as other applications requiring a small camera may be used. The camera 142 is intended for taking a picture of a view in front of the user similar to a digital camera. When operating the camera 142, the screen 112 may function as a viewfinder for the user. In addition, the camera 142 is equipped with a video capture feature allowing the camera to capture video.

Although the apparatus 100 includes two cameras 140 and 142, it will be appreciated that in another embodiment, only one camera may be included. By including only one camera, the cost of a portable electronic apparatus may be reduced. In yet another embodiment, more than two cameras may be used, or both cameras may be disposed on the front or both cameras may be disposed on the back of a portable electronic apparatus. The two cameras may be different and optimized for taking pictures and video in different environments. Alternatively, two cameras on the front or two cameras on the back of a portable electronic apparatus may be used to capture a 3D image.

While specific embodiments of the invention have been described and illustrated, such embodiments should be considered illustrative of the invention only and not as limiting the invention as construed in accordance with the accompanying claims.

What is claimed is:

1. A portable electronic apparatus having a front and a back, the portable electronic apparatus comprising:
a processor circuit enabled to execute a plurality of programs;
an output device for outputting output from the processor circuit;
an input device for receiving input, the input for controlling the processor circuit; and
an indicator for indicating a program being executed by the processor circuit.

2. The portable electronic apparatus of claim 1, wherein the output device is a display screen.

3. The portable electronic apparatus of claim 1, wherein the input device is a touchscreen.

4. The portable electronic apparatus of claim 3, wherein the output device comprises the touchscreen.

5. The portable electronic apparatus of claim 2, wherein the indicator is for indicating a type of program being executed by the processor circuit.

6. The portable electronic apparatus of claim 5, wherein the output device and the input device are disposed on the front, and wherein the indicator is disposed on the back.

7. The portable electronic apparatus of claim 5, wherein the output device and the input device are disposed on the front, and wherein the indicator is disposed on the side.

8. The portable electronic apparatus of claim 5 further comprising an environmental lighting system for providing environment lighting.

9. The portable electronic apparatus of claim 8 wherein the environmental lighting system comprises the indicator.

10. The portable electronic apparatus of claim 5, wherein portable electronic device further comprises a wireless network card.

11. A method for determining a program being executed on a processor circuit, the method comprising:
executing the program on the processor circuit;
outputting output to an output device from the processor circuit;
controlling the processor circuit using input from an input device; and
indicating the program being executed wherein indicating involves using an indicator.

12. The method of claim 11, wherein outputting involves outputting to a display screen disposed on a front of a portable electronic device.

13. The method of claim 11, wherein controlling involves receiving input from a touchscreen.

14. The method of claim 12, further comprising indicating a type of program being executed by the processor circuit.

15. The method of claim 14, wherein indicating involves indicating using an indicator disposed on a back of the portable electronic device.

16. The method of claim 14, wherein indicating involves indicating using an indicator disposed on a side of the portable electronic device.

17. The method of claim 14, further comprising reducing eyestrain.

18. The method of claim 17, wherein reducing eyestrain comprises providing environmental lighting from an environmental lighting system.

19. The method of claim 18, wherein providing environmental lighting indicates the type of program being executed by the processor circuit.

20. A computer-readable medium storing instruction codes for directing a processor circuit to carry out the method of claim 11.

21. A portable electronic tablet device for children comprising:
a body comprising acrylonitrile butadiene styrene;
a processor circuit enabled to execute a plurality of programs, the plurality of programs comprising games and educational programs;
a touchscreen device in communication with the processor circuit, wherein the touchscreen is 7 inches diagonally;
a plurality of cameras controlled by the processor circuit; and
an indicator for indicating a type of program being executed by the processor circuit, wherein the indicator provides environmental lighting to reduce eyestrain.
